(19) United States
(12) Patent Application Publication
(10) Pub. No.: US 2012/0065986 A1
(43) Pub. Date: Mar. 15, 2012

(54) HEALTHCARE MANAGEMENT SYSTEM, COMPUTER-READABLE NON-TRANSITORY STORAGE MEDIUM, AND COMPUTER-IMPLEMENTED METHOD FOR COMPILING A GUIDELINE MODEL INTO A RULE SET

(75) Inventors: Aleksandra TESANOVIC, EINDHOVEN (NL); Harald REITER, AACHEN (DE)

(73) Assignee: KONINKLIJKE PHILIPS ELECTRONICS N.V., EINDHOVEN (NL)

(21) Appl. No.: 13/204,742

(22) Filed: Aug. 8, 2011

Related U.S. Application Data
(60) Provisional application No. 61/382,107, filed on Sep. 13, 2010.

(51) Int. Cl. G06Q 50/00

(52) U.S. Cl. 705/2

(57) ABSTRACT

A healthcare management system comprising:
a guideline model database containing models of medical guidelines;
a computer system comprising a processor and a display; and
a computer-readable non-transitory storage medium containing instructions for execution by the processor, wherein the instructions cause the processor to perform the steps of:
   reading a guideline model from the guideline model database,
   displaying the guideline model on the display, wherein the guideline model is displayed as a diagram,
   receiving a set of annotations of the diagram,
   compiling the guideline model into a rule set using the annotations,
   writing the rule set into a rule database.

### CROSS REFERENCE TO RELATED APPLICATION

This patent application claims the priority benefit under 35 U.S.C. §119(e) of U.S. Provisional Application No. 61/382,107 filed on Sep. 13, 2010, the contents of which are herein incorporated by reference.

### TECHNICAL FIELD

The invention relates to compilation of a guideline model into a rule set for use by healthcare management systems

### BACKGROUND OF THE INVENTION

Patient pathways are a specific instantiation of the guidelines and are developed by the hospital experts to specify for that hospital what should be done in case of certain medication administration, labs, etc. This is, for example, because most hospitals have different lab-taking facilities so that taking labs in one hospital or outpatient centre on weekly basis is applicable only on monthly basis on another. These pathways are then used as a (manual) “tool” for clinical decision making. This holds both for the out-hospital care (remote patient management) and also in-hospital care.

Current standards of care in outpatient management, also holds for inpatient care, rely heavily on use of clinical guidelines to ensure best practices and the optimal care for the patient. Guidelines normally prescribe which medications the patient should be on, roughly how medication should be administered, what patient labs and vitals should be taken and when, etc. These guidelines reflect the benefit of the entire patient population and are generically applicable across countries and hospitals. How they are currently applied in clinical practice is that each centre uses the guidelines to develop (paper-based) patient pathway based on these guidelines. The patient pathways are a specific instantiation of the guidelines and are developed by the hospital experts to specify for that hospital what should be done in case of certain medication administration, or labs etc. This is because most hospitals have different lab-taking facilities so that taking labs in one hospital or outpatient centre on weekly basis is applicable only on monthly basis on another. Hospitals have certain equipment for patient monitoring while other do not etc. These pathways are then used as a “tool” for clinical decision making “Translating” guidelines into patient pathways can result in a large number of mutually dependent pathways that in detail describe what to do with the patient in case of a certain medication, lab value result, etc. How the professional is using them is to master them by applying in daily practice. This typically implies that senior, experienced medical professionals know by heart all the pathways and their interleaving, while the young ones or nurses are not aware of them.

### SUMMARY OF THE INVENTION

There are several problems associated with the creation and application of patient pathways. A first problem is that expert medical professionals need very good understanding of the medical guidelines, as well as the golden practice in their hospital to create patient pathways. Even with these prerequisites they are faced with tedious process of re-creating part of guidelines applicable for their institution and need always to take extra care to ensure the consistency of their pathways with guidelines. This is manual, lengthy and timely process, requiring also external reviews (by other experts) of the created pathways.

A second problem is that given the growing number of patients with multiple co-morbidities, e.g., heart failure patients that are normally population on remote patient monitoring systems, the number of pathways is likely to increase and interleaving between them becomes more prominent. In current medical practice, the detection of interleaving and dependencies of the pathways currently is done only in the head of the medical professional and greatly depends on his or her skills and experience level.

A third problem is that given the lack of medical experts and the trend to move the case from specialists (such a cardiologist) to non-specialists (GPs and nurses), the approach to creating and applying the pathways to patient care in a consistent and correct way becomes increasingly important.

A fourth problem is that patient pathways normally contain the generic thresholds for detecting certain conditions or changes in conditions. These are currently generic and applicable for the entire patient population. However, each patient is different and, for example, generic rule of 3 kg increase in weight implies immediate attention, should be adjusted for patients that have holidays and are likely to overeat, or the blood pressure over 130 is immediate medical attention should be adjusted for hypertension patients to a different level if they are normally tolerating it.

A fifth problem is that there is currently no support in clinical decision making that would provide indications on the pathways and their interleaving

Embodiments of the invention may address one or more of the above mentioned problems by providing the following elements, which may or may not be present in particular embodiments:

The authoring tool that provides models of the guidelines and support for customizing these models into pathways as well as annotation of pathways for later automatic processing

A database of guideline models, and patient pathways

A rule compiler that takes annotated pathways as input and produces the pathways rules

A database in which the rules are stored

A rule compiler that takes as input pathways from the pathways database and produces pathways rules that can be automatically evaluated

A rule evaluator that reacts on the incoming patient measurements (from home: vitals, surveys) or from hospital information system (labs, CTs, ECHO) by evaluating appropriate pathways rules

A clinical application (user interface) where (i) the rule evaluations as well as their interleaving are displayed, and (ii) editor is provided for adjusting personalizing rule thresholds for a particular patient depending on his/her current condition

A ‘computer-readable storage medium’ as used herein encompasses any storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device. An example of a computer-readable storage medium include, but are not limited to: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example a data may be retrieved over a modem, over the internet, or over a local area network.

‘Computer memory’ as used herein is an example of a computer-readable storage medium. Computer memory is any memory which is directly accessible to a processor. Examples of computer memory include, but are not limited to: RAM memory, registers, and register files.

‘Computer storage’ as used herein is an example of a computer-readable storage medium. Computer storage is any non-volatile computer-readable storage medium. Examples of computer storage include, but are not limited to: a hard disk drive, a USB thumb drive, a floppy drive, a smart card, a DVD, a CD-ROM, and a solid state hard drive. In some embodiments computer storage may also be computer memory or vice versa.

A processor as used herein encompasses an electronic component which is able to execute a program or machine executable instruction. References to the computing device comprising “a processor” should be interpreted as possibly containing more than one processor. The term computing device should also be interpreted to possibly refer to a collection or network of computing devices each comprising a processor. Many programs have their instructions performed by multiple processors that may be within the same computing device or which may even distributed across multiple computing device.

A ‘database’ as used herein encompasses a data file or repository which contains data that may be accessed by a processor. Examples of databases are, but are not limited to: a data file, a relational database, a file system folder containing data files, and a spreadsheet file.

A ‘remote patient management system’ as used herein is a system for remotely administering a care plan.

A ‘care plan’ as used herein is a day-to-day plan for managing a disease or health condition.

A ‘content element’ as used herein is content which may be provided to a patient and which may be integrated into a care plan for the patient. For instance a remote patient management system may present content elements for educating, motivating, or assessing a patient. Examples of these content elements include, but are not limited to: text messages, audio messages, or video messages, educational games, educational video games, questionnaires, surveys, quizzes, interactive videos. The term content element encompasses both multimedia presented to a patient and to media with which the patient interacts.

A ‘home infrastructure device’ as used herein is a device adapted for delivering the content elements to the patient. The home infrastructure device may comprise at least one diagnostic medical device for measuring a value of a patient's vital sign.

Content elements may be provided either by a hospital or an outpatient clinic or a disease management organization or a remote patient management system.

The term ‘vital sign’ as used herein refers to are any physical property of the patient which may be measured. Examples of vital signs include, but are not limited to: weight, blood sugar level, blood pressure, pulse/heart rate, SpO2, and bio-impedance

A ‘display’ as used herein is an electronic device adapted for graphically displaying text, images, multimedia clips, video, and other audio-visual content. Examples of a display include, but are not limited to: a computer monitor, the screen of a cellular telephone, a graphical user interface, and a television.

A ‘user interface’ as used herein is an interface which allows a user or operator to interact with a computer or computer system. A user interface may provide information or data to the operator and/or receive information or data from the operator. The display of data or information on a display or a graphical user interface is an example of providing information to an operator. The receiving of data through a keyboard, mouse, trackball, touchpad, pointing stick, graphics tablet, joystick, gamepad, webcam, headset, gear sticks, steering wheel, pedals, wired glove, dance pad, remote control, and accelerometer are all examples of receiving information or data from an operator.

In one aspect the invention provides for a healthcare management system. A healthcare management system as used herein encompasses an automated system which facilitates the management of a patient pathway or care plan. The healthcare management system comprises a guideline model database containing models of medical guidelines. Medical guidelines are guidelines or protocols for treating specific medical conditions. Models of medical guidelines are abstractions of medical guidelines in a machine-readable form. For instance a model medical guideline may contain a set of steps which are represented or may be represented by a flowchart. The healthcare management system further comprises a computer-readable storage medium containing instructions for execution by the processor. It is understood herein that the processor may be multiple processors within a single computer system or may also be multiple processors in multiple computer systems. Likewise the computer system may also comprise multiple computer systems. The instructions on the computer-readable storage medium may also be spread across or contained on multiple computer-readable storage mediums.

The instructions cause the processor to perform the step of reading a guideline model from the guideline model database. In this step a guideline model is retrieved from the guideline model database. The instructions further cause the processor to perform the step of displaying the guideline model on a display. In some embodiments, the display is a graphical user interface (GUI). The guideline model is displayed as a diagram. That is to say that the guideline model is graphically represented on the display. The instructions further cause the processor to perform the step of receiving a set of annotations of the diagram. In some embodiments the set of annotations is received using the graphical user interface. The set of annotations may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. As an example, the guideline may be displayed as a diagram consisting of various elements. A user could use the graphical user interface to label the function of each of the elements on the diagram.

The instructions further cause the processor to perform the step of compiling the guideline model into a rule set using the annotations. The guideline model is displayed as a diagram and then the individual elements of the guideline model are able to be annotated using the graphical user interface. The compilation process turns this diagram into a rule set. The rule set may consist of events happening at specific times, actions to be performed by the patient and also decision points or steps in the flow of the rule set. The instructions further cause the processor to perform the step of writing the rule set into a rule database. A rule database as used herein as a database used as a repository for a collection of rules which can later be compiled into a patient pathway.

In another embodiment the instructions further cause the processor to perform the step of receiving a set of modifications to the diagram. In some embodiments the modifications are received using the graphical user interface. The set of modifications may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. The instructions further cause the processor to perform the step of modifying the guideline model in accordance with the set of modifications before compiling the guideline model into a rule set. In this embodiment a user is able to use the graphical user interface to modify the structure and change the elements which comprise the diagram and therefore the guideline model. In this way a healthcare professional may use his or her personal knowledge to modify the guideline model. Guideline models may also be updated for new clinical information or changes in regulations. Receiving modifications via a graphical user interface may also be a benefit as it forces a healthcare professional to use the graphical user interface and not use a paper. This reduces the likelihood of another healthcare professional misinterpreting the changes to the guideline model.

In another embodiment the annotations comprise personalization options. The personalization options comprise a predetermined option which may be selected to personalize the rule set. For instance the efficacy or effectiveness of a particular patient pathway may be affected by the patient's attitudes, beliefs or personal habits. Questions or options can be inserted into the rule set so that a healthcare professional who is acquainted with the patient can later select the options which best describe the patient or best describe or modify the treatment method in a way to increase the effectiveness of the patient pathway for the patient.

In another embodiment the instructions further cause the processor to perform the step of reading the rule set from the rule database. In this step the rule set is retrieved from the rule database. The instructions further cause the processor to perform the step of displaying personalization questions on the display. In some embodiments, the display is a graphical user interface. The personalization questions are generated using the personalization options. The instructions further cause the processor to perform the step of receiving a personalization selection. In some embodiments the personalization selection is received using the graphical user interface. The personalization selection may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. The instructions further cause the processor to perform the step of compiling a patient pathway using the rule set and the personalization selection. In this embodiment the personalization options are used to generate questions which are then used to personalize the rule set into a patient pathway. A patient pathway as used herein encompasses a plan or a care plan, or treatment plan which provides for a path for a given course of treatment. For instance a patient pathway may be a treatment plan for managing a disease such as hypertension or a treatment plan for recovering from a medical condition such as a heart attack.

In another embodiment the instructions further cause the processor to perform the step of reading a second rule set from the rule database. The personalization questions relate to both the rule set and the second rule set. The patient pathway is compiled using the rule set, the second rule set, and the personalization selection. In this embodiment two existing rule sets are combined into a single patient pathway. This particular embodiment is particularly advantageous because two rule sets which were prepared separately are combined into a single patient pathway or treatment plan.

In another embodiment the instructions further cause the processor to perform the step of checking the combination of the rule set and the second rule set for self-consistency. Essentially the rule set and the second rule set need to be checked to see if contradictory steps are taken. In some embodiments the rule database could contain additional rules which are used to see if rules from the rule set and the second rule set are self-consistent or not. The instructions further cause the processor to perform the step of displaying an error message on the display if the rule set and the second rule set are not self-consistent. In some embodiments, the display is a graphical user interface. The instructions further cause the processor to perform the step of receiving correction data if the error message is displayed. In some embodiments the correction data is received using the graphical user interface. The correction data may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. The instructions further cause the processor to perform the step of modifying the combined rule set and second rule set using the correction data. In this embodiment if the rule set and the second rule set are not self-consistent then an error message is displayed on the graphical user interface and corrections may be made using the graphical user interface that are then used to combine the rule set and second rule set self-consistently. For instance the graphical user interface could identify the inconsistencies and then pose a question which would resolve the lack of self-consistency.

In another embodiment the healthcare management system further comprises a remote patient management system. The remote patient management system comprises an application hosting device for providing patient data. The patient pathway comprises machine readable instructions executable by a remote patient management system. The instructions implement a rule evaluator software module executing the patient pathway depending upon the patient data. The patient data may contain physical measurements taken by the remote patient management system or the patient data may also include responses to surveys, questionnaires, or quizzes. In this embodiment the patient data is used to determine the course of the patient pathway.

In another embodiment the healthcare management system further comprises a guideline database. The instructions further cause the processor to perform the step of reading a guideline from the guideline database. The instructions further cause the processor to perform the step of generating the guideline model from the guideline. The instructions further cause the processor to perform the step of writing the guideline model into the guideline model database. The guideline may take a variety of different forms. The guideline may be a timeline or a diagram. For instance a guideline may be a sketch of a flowchart or diagram by a physician or it may be a formal document issued by a clinic or a hospital. In some embodiments natural language processing may be used for interpreting the guideline or the guideline may be scanned and then the diagram may be interpreted by the computer using a combination of natural language processing and/or pattern recognition.

In another embodiment the guideline model is generated using a natural language processing module. In this embodiment text in the guideline is processed to determine the form of the guideline model.

In another embodiment the diagram is a flowchart. The flowchart contains elements such as boxes describing actions to be taken by the patient; decision steps determined by answering question or from data from for example a remote patient management system, and also the structure of the diagram itself. For instance arrows or question boxes may show the flow of the diagram.

In another embodiment the diagram comprises boxes indicating elements of the guideline model. The annotations indicate if each element is any one of a decision step, an action and a query for data. The query for data may in some embodiments be a request for data from a remote patient management system.

In another aspect the invention provides for a computer-implemented method for compiling a guideline model into a rule set. The method comprises the step of reading a guideline model from a guideline model database. The guideline model database contains models of medical guidelines. The method further comprises the step of displaying the guideline model on a display. In some embodiments, the display is a graphical user interface. The guideline model is displayed as a diagram. The method further comprises the step of receiving a set of annotations of the diagram. In some embodiments the set of annotations is received using the graphical user interface. The set of annotations may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. The method further comprises the step of compiling the guideline model into a rule set using the annotations. The method further comprises the step of bringing the rule set into a rule database.

In another embodiment the method further comprises the step of receiving a set of modifications to the diagram. In some embodiments the set of modification is received using the graphical user interface. The set of modifications may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. The method further comprises the step of modifying the guideline model in accordance with the set of modifications before compiling the guideline model into a rule set. In another embodiment the annotations comprise personalization options. The personalization options comprise a predetermined option which may be selected to personalize the rule set.

In another embodiment the method further comprises the step of reading the rule set from the rule database. The method further comprises the step of displaying personalization questions on the display. In some embodiments, the display is a graphical user interface. The personalization questions are generated using the personalization options. The method further comprises the step of receiving a personalization selection. In some embodiments the personalization selection is received using the graphical user interface. The personalization selection may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. The method further comprises the step of compiling a patient pathway using the rule set and the personalization selection.

In another embodiment the method further comprises the step of reading a second rule set from the rule database. The personalization question relates to both the rule set and the second rule set. The patient pathway is compiled using the rule set, the second rule set, and the personalization selection.

In another aspect the invention provides for a computer-readable non-transitory storage medium containing instructions for execution by the processor of a healthcare management system. Execution of the instructions further cause the processor to perform the step of reading a guideline model from a guideline model database. The guideline model database contains models of medical guidelines. Execution of the instructions further causes the processor to perform the step of displaying the guideline model on the display. In some embodiments, the display is a graphical user interface. The guideline model is displayed as a diagram. Execution of the instructions further causes the processor to perform the step of receiving a set of annotations of the diagram. In some embodiments the set of annotation is received using the graphical user interface. The set of annotations may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. Execution of the instructions further cause the processor to perform the step of compiling the guideline model into a rule set using the annotations. Execution of the instructions further cause the processor to perform the step of writing the rule set into a rule database.

In another embodiment execution of the instructions further cause the processor to perform the step of receiving a set of modifications to the diagram. In some embodiments the set of modifications to the diagram are received using the graphical user interface. The set of modifications may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. Execution of the instructions further cause the processor to perform the step of modifying the guideline model in accordance with the set of modifications before compiling the guideline model into a rule set.

In another embodiment the annotations comprise personalization options. The personalization options comprise a predetermined option which may be selected to personalize the rule set.

In another embodiment execution of the instructions further causes the processor to perform the step of reading the rule set from the rule set database. Execution of the instructions further cause the processor to perform the step of displaying personalization questions on the display. In some embodiments, the display is a graphical user interface. The personalization questions are generated using the personalization options. Execution of the instructions further causes the processor to perform the step of receiving a personalization selection. In some embodiments the step of receiving a personalization selection is performed using the graphical user interface. The personalization selection also is received in other ways. For example the set of annotations may be received by, but are not limited to: receiving key board entry from a user interface, receiving data from a mouse, receiving data from a user interface as defined above, receiving a data file, and receiving data on a computer-readable storage medium. Execution of the instructions further causes the processor to perform the step of compiling a patient pathway using the rule set and the personalization selection.

### BRIEF DESCRIPTION OF THE DRAWINGS

In the following preferred embodiments of the invention will be described, by way of example only, and with reference to the drawings in which:

FIG. 1 shows a block diagram which illustrates an embodiment of a method according to the invention;

FIG. 2 shows a block diagram which illustrates a further embodiment of a method according to the invention;

FIG. 3 shows a diagram which illustrates a healthcare management system according to an embodiment of the invention;

FIG. 4 shows a diagram which illustrates a healthcare management system according to a further embodiment of the invention;

FIG. 5 shows an example of a guideline model 500 according to an embodiment of the invention; and

FIG. 6 may be alternatively interpreted as a graphical representation of a patient pathway or as an annotated guideline model according to an embodiment of the invention.

### DETAILED DESCRIPTION OF THE EMBODIMENTS

Like numbered elements in these Figures are either equivalent elements or perform the same function. Elements which have been discussed previously will not necessarily be discussed in later Figures if the function is equivalent.

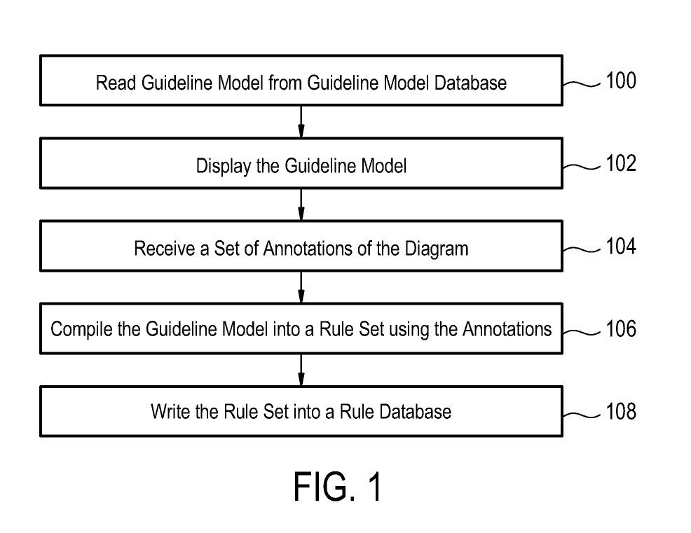

FIG. 1 shows an embodiment of a method according to the invention. This method may be executed as a computer-implemented method or it may be implemented in the form of instructions stored on a computer-readable non-transitory storage medium for a computer system. In step 100 a guideline model is read from a guideline model database. In step 102 the guideline is displayed or rendered on a display. In step 104 a set of annotations of the diagram is received. In some embodiments the annotations of the diagram are received from the graphical user interface. The set of annotations may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. In step 106 the guideline model is compiled into a rule set using the annotations. Finally in step 108 the rule set is written into a rule database.

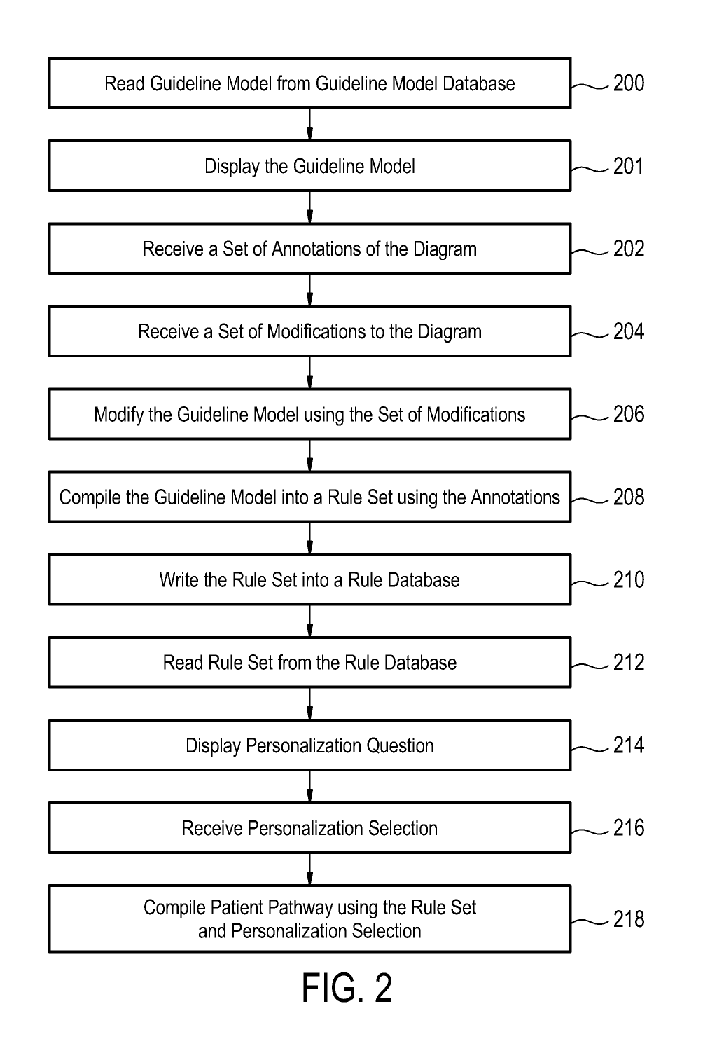

FIG. 2 shows a further embodiment of a method according to the invention. In step 200 a guideline model is read from a guideline model database. In step 201 the guideline model is displayed or rendered on a display. In step 202 a set of annotations of the diagram is received. In some embodiments set of annotations is received from the graphical user interface. The set of annotations may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. In step 204 a set of modifications to the diagram is received. In some embodiments the set of modifications to the diagram are received from the graphical user interface. The set of modifications may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. In step 206 the guideline model is modified using the set of modifications. In step 208 the guideline model is compiled into a rule set using the annotations and the modified guideline model. In step 210 the rule set is written into a rule database. In step 212 the rule set is read from the rule database that it was just written to. In step 214 one or several personalization questions are displayed on the display. The graphical user interface of step 214 may be the same or it may be a different display from those used in steps 201, 202 and 204. In step 216 a personalization selection is received. In some embodiments the personalization selection is received from the graphical user interface. The personalization selection may also be received in other ways. For example the set of annotations may be received by, but are not limited to: receiving key board entry from a user interface, receiving data from a mouse, receiving data from a user interface as defined above, receiving a data file, and receiving data on a computer-readable storage medium. Essentially the personalization selection is a response to the personalization questions. Finally, in step 218 a patient pathway is compiled using the rule set and the personalization selection.

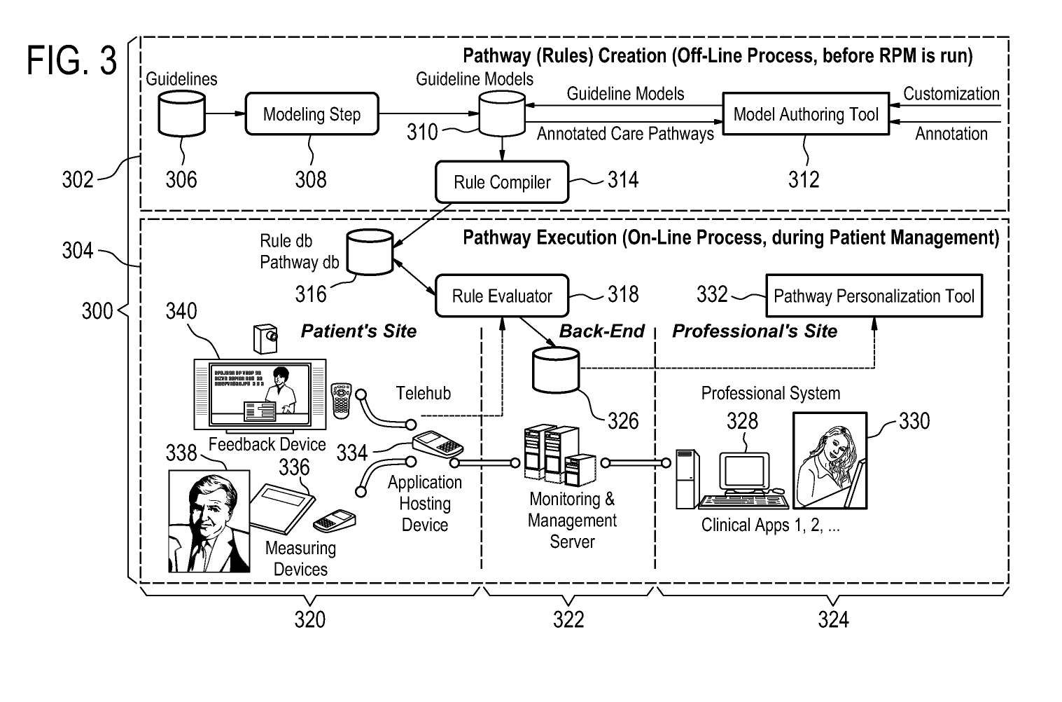

FIG. 3 shows a healthcare management system 300 according to an embodiment of the invention. The healthcare management system comprises a computer system 302 and a remote patient management system 304. The computer system 302 comprises a guideline database 306. The guideline database 306 stores guidelines of treatment plans and/or patient pathways. The guideline database 306 is connected to a guideline model generating module 308. The guideline model generating module 308 is a program or software module which generates guidelines from the guideline database 306. The guideline model generating module 308 is connected to a guideline model database. The guideline model generating module 308 deposits guideline models into the guideline model database 310. There is a model offering tool 312 which is a combination of hardware and software which a user can use to take a guideline model and annotate it.

Annotated guideline models are returned to the guideline model database 310 by the model offering tool 312. There is a rule compilation module 314 which reads the guideline model database 310 and compiles annotated guideline models into sets of rules. The rule compilation module 314 deposits sets of rules into a rule database 316. In this example the rule database and the patient pathway database 316 are the same database, in other embodiments they may be separate databases. A rule evaluator 318 is able to read the rules and/or patient pathways from the database 316. The remote patient management system is divided into three layers. There is a patient site 320, a back end site 322 and a healthcare professional site 324. The back end portion 322 of the remote patient management system 308 is a server 326 which is labeled ‘back end server’ in this Figure. The back end server 326 is able to execute the rule evaluator module 318 and receive input from the patient portion 320 of the remote patient management system 304.

At the healthcare professional site 324 there is a computer system 328 or other user interface with which a healthcare professional 330 can communicate with the back end server 326. The healthcare professional 330 may use a pathway personalization tool 332 which is implemented on the healthcare professional's computer system 328. The pathway personalization tool 332 may be used to personalize a rule into a patient pathway. The patient site 320 of the remote patient management system 304 comprises an application hosting device 334. The application hosting device 334 is an embedded computer system which connects to the back end server 326. The application hosting device is also connected to vital sign measurement devices 336 which are designed for taking vital sign or measurements of a patient 338. Additionally the patient 338 may also interact with the remote patient management system 304 through a patient user interface 340.

The guideline database 306 contains the known medical guidelines, e.g., for heart failure and its comorbidites. In some embodiments, the guideline database may be a web repository of, e.g., European Society of Cardiology or similar body, that already contains guidelines in a machine readable format such as the portable document format or PDF format. Using a modeling tool 308 (possibly with modeling expert input), a model of the guidelines may be created and stored in a database. From here, the authoring tool 312 takes models of the guidelines 310 and presents them in a graphical format to the medical expert. Using the authoring tool 312 the expert can modify the model, making constituents components more detailed than components in guidelines are, and annotate each component of the pathways such that it can be appropriately used for automatic rule extraction.

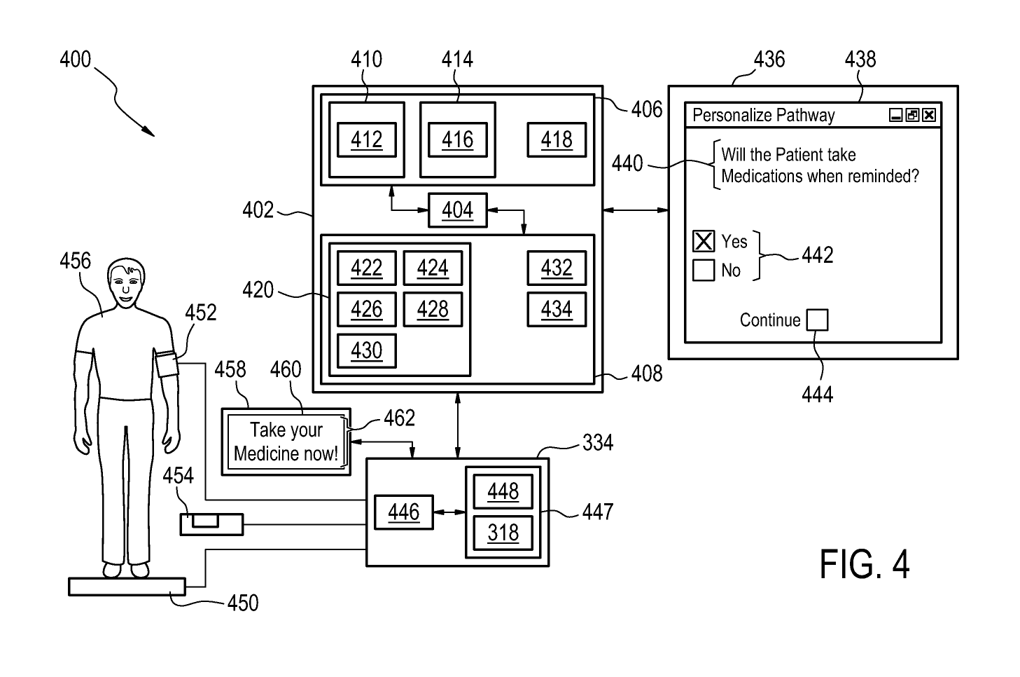

FIG. 4 shows a block diagram which illustrates a health care management system 400 according to an embodiment of the invention. In this embodiment the healthcare management system 400 comprises a computer system 402 connected to an application hosting device 334. The computer system 402 comprises a processor 404 which is connected to a computer storage 406 and a computer memory 408. The computer storage 406 contains a guideline model database 410 which contains a guideline model 412. The computer storage 406 also contains a rule database 414 which contains a set of rules 416. The computer storage 406 also contains a compiled patient pathway 418.

The computer memory 408 contains a program 420 for executing a computer implemented method according to an embodiment of the invention. The program 420 may contain various software modules for instance in this embodiment the program contains a guideline model generation module. The guideline model generation module 422 is able to take a guideline and turn it into a guideline model 412. The program 420 further comprises a guideline rendering module 424. The guideline rendering module 424 is able to take a guideline model 412 and render it on a display 438. The program 420 further comprises a rule compilation module 426. The rule compilation module 426 is able to take a guideline model 412 and a set of annotations 432 and compile them into a set of rules 416. The program 420 further comprises a question generation module 428 for displaying personalization questions on the display 438.

For instance, in this embodiment a user interface 436 is shown as being connected to the computer system 402. The user interface 436 comprises a display 438. In this example, the display 438 is a graphical user interface. On the display 438 a personalization question 440 is displayed. There is a region of the display 438 which contains a selector 442 for answering the personalization question 440. The display 438 is also shown as having a button 444 which indicates that a selection for the answer to the personalization question 440 has been made. The display 438 is then able to transfer the response to the personalization question 440 or questions to the computer system 402 for use by a patient pathway compilation module 430 which is a part of the program 420. The patient pathway compilation module 430 compiles the set of rules 416 into the patient pathway 418.

The computer memory 408 is shown as further containing a set of annotations 432 and also a set of modifications 434. The set of modifications 434 are modifications which may be received for modifying the guideline model 412. The set of annotations 432 and the set of modifications 434 may be received for example from: a graphical user interface, a computer-readable storage medium, via email, via a computer network, or from a user interface.

The computer system 402 is also connected to application hosting device 334. The application hosting device comprises a processor 446 which is connected to computer memory 447. In the computer memory is a rule evaluator 318. Also within the memory is the patient pathway 448. For instance the patient pathway 448 could be copied from the computer storage 406 onto the computer memory 447 of the application hosting device 334. The application hosting device is also shown as being connected to a variety of vital sign measuring devices 450, 452, 454. For instance a patient 456 is shown as being on a scale 450 having his or her blood pressure measured by a blood pressure cuff 452 that is next to a blood sugar analysis device 454. The scale, blood pressure cuff 452 and blood sugar analysis device 454 are shown as being networked or connected to the application hosting device 334. The application hosting device 334 is also shown as being connected to a user interface 458 which has a display 460. In this example the display 460 has a message 462 instructing the patient 456 as to what to do in order to follow the patient pathway 448. Alternatively the display 460 could also pose questions to the patient 456 to gain information for operation of the rule evaluator 318.

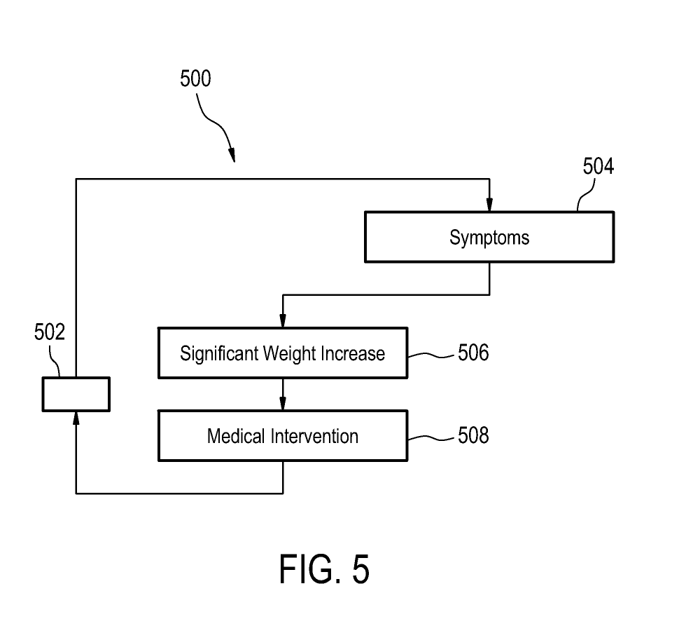

FIG. 5 shows an example of a guideline model 500 according to an embodiment of the invention. Block 502 indicates the start or end of a cycle of the guideline. An arrow from block 502 to block 504 indicates that block 504 is performed next. In block 504 symptoms are checked for. The symptoms may be for instance checked for by reading data from the remote patient management system. After block 504 is performed block 506 is performed. In block 506 significant weight increase is checked for. If there is significant weight increase then block number 508 is performed. In block number 508 a medical intervention is performed to deal with the increased weight. This may for instance involve a change in the patient's diet or the use of a medication such as a diuretic.

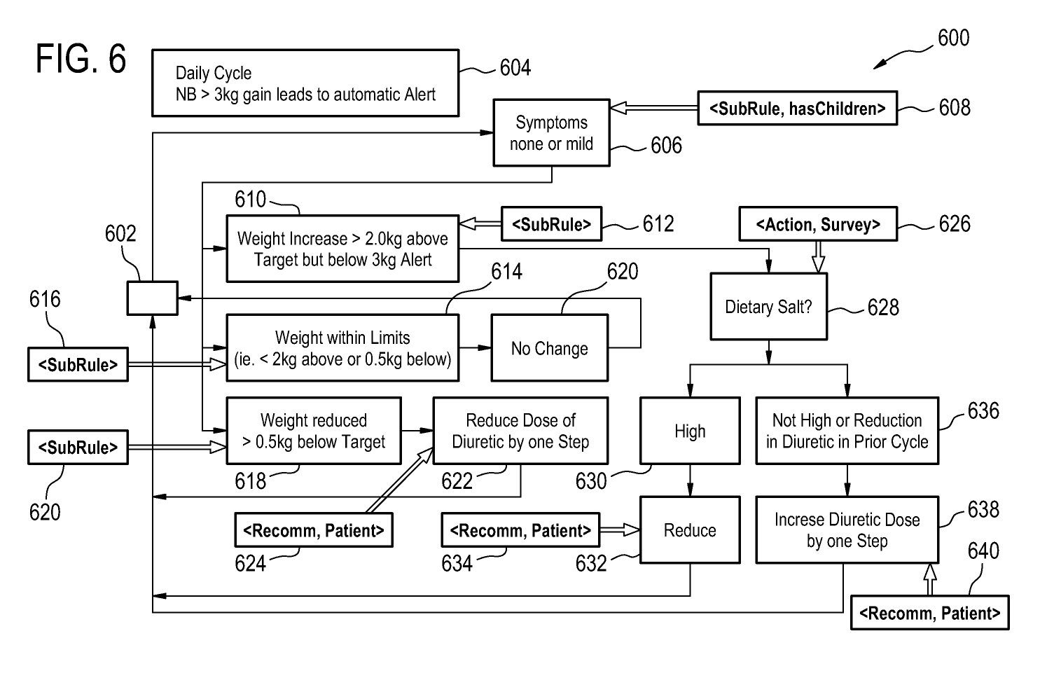

FIG. 6 may be alternatively interpreted as a graphical representation of a patient pathway 600 or as an interpreted as an annotated guideline model.

The patient pathway 600 is shown as starting and ending with block number 602. After block 602 part of a daily cycle 604 is performed. In this cycle the body weight of the subject is detected at a greater than 3 kg gain leads to an automatic alert by the remote patient management system. Next, block 606 is performed. In block 606 symptoms are determined in this step. There is an annotation 608 which indicates that block 606 is a sub-rule and has children or sub-rules. After block 606 is performed, blocks 610, 614 and block 618 are checked. In block 610 if the weight increase is 2 kg or above target or below 3 kg a first branch of operations is performed. Block 610 is labeled with annotation 612 as a sub-rule. Block 614 is another sub-rule or child rule of block 606. If the weight is within limits that is below 2 kg or above 0.5 kg the next block that is performed is a no change block 620 and the method returns to the start or end block 602. Block 614 is labeled with a sub-rule block 616. Block 618 is also checked after block 606 is performed. If the weight reduced is greater than 0.5 kg below target then block 622 is performed.

In block 622 the dose of the diuretic is reduced. Block 618 is labeled as a sub-rule 620. Block 624 is labeled as a recommendation for the patient to perform. After the diuretic has been reduced by one step block 622 goes to the start-end block 602. Returning to the earlier program branch after block 610 is performed a survey is performed in block 628. The question is how much dietary salt has been eaten. Block 628 is labeled as an action block of type survey. If the answer to the question in block 628 is high then block 630 is performed. The patient is then recommended to reduce the sodium intake in block 632. Block 632 is labeled as a recommendation to the patient by annotation 634. If the answer to the question in block 628 is that the salt intake is not high or that the dosage of diuretic was reduced in the prior cycle of the patient pathway 600 then block 638 is performed. Block 638 is a recommendation to the patient to increase the diuretic by one dosage step. Block 638 is labeled as a recommendation to the patient by annotation number 640.

Using the authoring tool 312 of FIG. 3, the medical expert may refine how weight targets are checked and what kind of symptoms to look for and also specify in more detail what kind of medical intervention can be achieved, as shown in FIG. 5. The tool 312 enables to add more nodes and refine the nodes. So the node with weight increase from FIG. 3 may be further refined to specific weight targets as shown in FIG. 5. Similarly, the node on symptoms from FIG. 1 can be expanded to include what kind of symptoms should be watched for, etc.

Further, the professional can annotate each node with indications I node is SubRule, Action, Outcome, Recommendation (also to whom, patient or professional).

The annotated pathway may be stored in the model database from where the Rule compiler takes the pathway and based on the annotations creates rule database. Below is an exemplary algorithm in pseudocode:

| | |
|---|---|
| 1. | Start from the root node |
| 2. | If node marked as <SubRule> add it to the RuleSet |
| | (RuleSet={<SubRule>}) |
| 3. | Move to another node in depth first manner |
| 4. | If node marked with Action GoTo 8 |
| 5. | If node marked with Recommendation GoTo 12 |
| 6. | If tree traversed GoTo 14 |
| 7. | Go to 1 |
| 8. | Take RuleSet and Action and Construct a Rule as Rule= IF |
| | <Subrule> and <Subrule> and . . . THEN ACTION; add |
| | rule to the rule database RuleSet=RuleSetU {Rule} |
| 9. | Re-start tree traversal from the Action node, |
| | traversing the remaining sub-tree only and |
| | adding the annotations of the nodes as they come Action, |
| | Outcome, until Recommendation is reached and there is a |
| | triplet <Action, Outcome, Recommendation/User> |
| 10. | Take the tripled from 9 and Construct the rule IF |
| | <Outcome> . . . THEN Recommendation/User; add rule to |
| | rule database RuleSet=RuleSetU {Rule} |
| 11. | GoTo 1 |
| 12. | Construct the rule IF <Subrule> and <Subrule> and . . . |
| | THEN Recommendation/User; add rule to rule database |
| | RuleSet=RuleSetU {Rule} |
| 13. | GoTo 1 |
| 14. | End |

When the algorithms runs on the pathways in FIG. 5, w the following (subset of) RuleSet can be obtained and stored in rules database:

```
  IF symptoms none or mild AND 3kg above the target>Weight >2kg
  above the
target
  THEN trigger Salt Intake Survey
  IF symptoms none or mild
  AND 3kg above the Target>Weight >2.0kg above Target
  AND Salt intake High
  THEN trigger Recommendation to reduce salt intake
  IF symptoms none or mild AND 3kg above the Target>Weight >2.0kg
  above
Target AND Salt intake Low
  THEN trigger Recommendation to Increase diuretics dose
```

These rules may stored in the rule database with the tag that indicated so which pathways they belong, can now be used for automatic assessment and application in clinical practice (as illustrated in the bottom part of FIG. 6).

These rules may be executing and/or applied as patient pathways in clinical practice. The process is triggered by incoming measurement from the patient side (result of a survey or vitals measurement) or from incoming lab results from hospital electronic health records. Incoming measurement will trigger the Rule evaluator to evaluate the Rules in RuleSet and thereby trigger appropriate Recommendation either to the patient or to the professional.

A rule evaluator may also flag the conflicting recommendation from the various pathways. For example, there could be a pathway for the diuretic management that could have a rule:

IF symptoms none or mild AND diuretics changed in previous cycle THEN Recommendation to Reduce diuretics dose

The rule evaluator could also detect the conflict by comparing the Recommendations. If recommendations refer to same medication or lifestyle change but have different indications (reduce vs increase, stop vs start, change dose vs remain on the same dose) and belong to different pathways this will be explicitly flagged in the clinical application.

The rules and/or pathways may also be personalized. As mentioned above, pathways normally contain the generic thresholds for detecting certain conditions or changes in conditions and there is a need to enable personalization of these. This can be achieved with the Pathways personalization tool, which will display all the rules to the nurse and enable her to change thresholds associated with the rules for that particular patient.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### LIST OF REFERENCE NUMERALS

300 healthcare management system
302 computer system
304 remote patient management system
306 guideline database
308 guideline model generating module
310 guideline model database
312 model authoring tool
314 rule compilation module
316 rule database and patient pathway database
318 rule evaluator
320 patient site
322 backend site
324 healthcare professional site
326 backend server
328 computer system
330 healthcare professional
332 pathway personalization tool
334 application hosting device
336 vital sign measurement device
338 patient
340 patient user interface
400 healthcare management system
402 computer system
404 processor
406 computer storage
408 computer memory
410 guideline model database
412 guideline model
414 rule database
416 set of rules
418 patient pathway
420 program
422 guideline model generation module
424 guideline rendering module
426 rule compilation module
428 question generation module
430 patient pathway compilation module
432 set of annotations
434 set of modifications
436 user interface
438 display
440 personalization question
442 selection for questions
444 button
446 processor
447 computer memory
448 patient pathway
450 scale
452 blood pressure cuff
454 blood sugar analysis device
456 patient
458 user interface
460 display
462 message
500 guideline model
502 start/end of model cycle
504 check for symptoms
506 check for weight increase
508 medical intervention
600 patient pathway
602 start/end block

What is claimed is:

1. A healthcare management system comprising:
a guideline model database containing models of medical guidelines;
a computer system comprising a processor and a display; and
a computer-readable storage medium containing instructions for execution by the processor, wherein the instructions cause the processor to perform the steps of:
reading a guideline model from the guideline model database,
displaying the guideline model on the display, wherein the guideline model is displayed as a diagram,
receiving a set of annotations of the diagram,
compiling the guideline model into a rule set using the annotations,
writing the rule set into a rule database.

2. The healthcare management system of claim 1, wherein the instructions further cause the processor to perform the steps of:
receiving a set of modifications to the diagram; and
modifying the guideline model in accordance with the set of modifications before compiling the guideline model into a rule set.

3. The healthcare management system of claim 1, wherein the annotations comprise personalization options, wherein the personalization options comprise a predetermined option which may be selected to personalize the rule set.

4. The healthcare management system of claim 3, wherein the instructions further cause the processor to perform the steps of:
reading the rule set from the rule database;
displaying personalization questions on the display, wherein the personalization questions are generated using the personalization options;
receiving a personalization selection; and
compiling a patient pathway using the rule set and the personalization selection.

5. The healthcare management system of claim 4, wherein the instructions further cause the processor to perform the step of reading a second rule set from the rule database; wherein the personalization questions relate to both the rule set and the second rule set; and wherein the patient pathway is compiled using the rule set, the second rule set, and the personalization selection.

6. The healthcare management system of claim 5, wherein the instructions further cause the processor to perform the steps of:
checking the combination of the rule set and the second rule set for self consistency;
displaying an error message on the display if the rule set and the second rule set are not self consistent;
receiving correction data if the error message is displayed; and
modifying the combined rule set and second rule set using the correction data.

7. The healthcare management system of claim 4, wherein the healthcare management system further comprises a remote patient management system, wherein the remote patient management system comprises an application hosting device for providing patient data, wherein the patient pathway comprises machine readable instructions executable by a remote patient management system, wherein the instructions implement a rule evaluator software module executing the patient pathway depending upon the patient data.

8. The healthcare management system of claim 1, wherein the healthcare management system further comprises a guideline database, wherein the instructions further cause the processor to perform the steps of:
reading a guideline from the guideline database;
generating the guideline model from the guideline; and
writing the guideline model into the guideline model database.

9. The healthcare management system of claim 8, wherein the guideline model is generated using a natural language processing module.

10. The healthcare management system of claim 1, wherein the diagram is a flowchart.

11. The healthcare management system of claim 1, wherein the diagram comprises boxes indicating elements of the guideline model, and wherein the annotations indicate if each element is any one of: a decisions step, an action, and a query for data.

12. The healthcare management system of claim 1, wherein the display is a graphical user interface.

13. A computer-implemented method for compiling a guideline model into a rule set, wherein the method comprises the steps of:
reading a guideline model from a guideline model database, wherein the guideline model database contains models of medical guidelines;
displaying the guideline model on a display, wherein the guideline model is displayed as a diagram,
receiving a set of annotations of the diagram,
compiling the guideline model into a rule set using the annotations,
writing the rule set into a rule database.

14. The computer-implemented method of claim 13, wherein the method further comprises the steps of:
receiving a set of modifications to the diagram; and
modifying the guideline model in accordance with the set of modifications before compiling the guideline model into a rule set.

15. The computer-implemented method of claim 13, wherein the annotations comprise personalization options, wherein the personalization options comprise a predetermined option which may be selected to personalize the rule set.

16. The computer-implemented method of claim 15, wherein the method further comprises the steps of:
reading the rule set from the rule database;
displaying personalization questions on the display, wherein the personalization questions are generated using the personalization options;
receiving a personalization selection; and
compiling a patient pathway using the rule set and the personalization selection.

17. The healthcare management system of claim 16, wherein the method further comprises the step of reading a second rule set from the rule database; wherein the personalization questions relates to both the rule set and the second rule set; and wherein the patient pathway is compiled using the rule set, the second rule set, and the personalization selection.

18. A computer-readable non-transitory storage medium containing instructions for execution by the processor of a healthcare management system, wherein execution of the instructions cause the processor to perform the steps of:
reading a guideline model from a guideline model database, wherein the guideline model database contains models of medical guidelines;
displaying the guideline model on a display, wherein the guideline model is displayed as a diagram;
receiving a set of annotations of the diagram;
compiling the guideline model into a rule set using the annotations; and
writing the rule set into a rule database.

19. The computer-implemented method of claim 18, wherein execution of the instructions further cause the processor to perform the steps of:
receiving a set of modifications to the diagram; and
modifying the guideline model in accordance with the set of modifications before compiling the guideline model into a rule set.

20. The computer-implemented method of claim 18, wherein the annotations comprise personalization options, wherein the personalization options comprise a predetermined option which may be selected to personalize the rule set.

21. The computer-implemented method of claim 20, wherein execution of the instructions further cause the processor to perform the steps of:
reading the rule set from the rule database;
displaying personalization questions on the display, wherein the personalization questions are generated using the personalization options;
receiving a personalization selection; and
compiling a patient pathway using the rule set and the personalization selection.
